(19) United States
(12) Patent Application Publication
(10) Pub. No.: US 2005/0132161 A1
(43) Pub. Date: Jun. 16, 2005

(54) Creation of virtual memory space in a memory

(75) Inventors: Jakke Makela, Turku (FI); Marko T. Ahvenainen, Ruutana (FI); Tapio Hill, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/737,189

(22) Filed: Dec. 15, 2003

(51) Int. Cl. G06F 12/00

(52) U.S. Cl. 711/170

(57) ABSTRACT

The invention relates to a method of creating a virtual memory space in a memory. In order to improve the efficiency of the memory, the method comprises determining whether additional memory space is needed in the memory. If additional memory space is needed, selected portions of memory content stored in the memory are compressed. Memory space which is no longer needed by the compressed selected portions of memory content is released for use as virtual memory space. The invention relates equally to a memory manager controlling a memory accordingly, to a system comprising such a memory manager and a memory, and to a software realizing the steps of the method when running in a memory manager.

### FIELD OF THE INVENTION

The invention relates to a method of creating a virtual memory space in a memory. The invention relates equally to a memory manager controlling a memory, to a system comprising a memory and a memory manager, and to a software program product which may run in a memory manager controlling a memory.

### BACKGROUND OF THE INVENTION

Frequently, memory space is particularly valuable in a device. In mobile information devices, for example, a Random Access Memory (RAM) employed as an execution memory is one of the most costly components, and any measure allowing to save RAM is thus of value.

Most software-based devices comprise a non-executable persistent storage and an execution memory like a RAM. As long as the device is inactive, all data is stored in the persistent storage. There are different approaches for making use of the execution memory when the device is active, in order to enable applications to be run.

In a first approach, all application data is copied at a boot-up time of the device from the persistent storage into the execution memory. The required execution memory space is thus considerable.

In a second approach, only the data of the operating system is loaded into the execution memory at a boot-up time of the device. The data belonging to specific applications are only copied into the execution memory when a respective application is started. When the application has been terminated, the space in the RAM is released again. Compared to the first approach, the required execution memory space is reduced significantly.

A further reduction can be achieved with a third approach, which is based on demand paging. In the third approach, again only the operating system is loaded into the execution memory at a boot-up time of the device. When a specific application is started, however, only parts of the application data are copies into the execution memory. When a thread in execution runs out of code, a page fault takes place, and the missing part of the application data is copied into the execution memory. This approach takes advantage of the fact that most applications have large portions of code for exceptional situations that seldom occur. It is thus not necessary to keep this supplementary code in the memory during the entire runtime of the application. In this third approach, unmodified text pages in the execution memory are overwritten after the free memory space has been used up. The required size of the execution memory is smaller than with the second approach. But the memory management overhead may be significant, if the execution memory is small. Moreover, an end-of-memory condition is still possible, because modified pages shall not be overwritten.

For a fourth approach, the device comprises in addition a paging storage. Inactive modified pages can then be removed from the execution memory and stored into the paging storage, whenever an end-of-memory condition occurs in the execution memory. The size of the execution memory can be smaller than in the third approach, and an end-of-memory condition results only in the case of an end-of-paging storage condition, which can be considered to be rare.

However, in particular, mobile devices may not comprise such an additional paging storage. Thus, the fourth approach is not applicable for all devices.

For the mobile terminal ‘Nokia 7650’, a commercial product called Space Doubler™ is known, which enables a more efficient use of the memory of a file system. The Space Doubler takes care that all executable code in the memory of the file system is compressed automatically for a permanent maximization of the capacity. Only the files belonging to a respectively starting application are decompressed. When the application is terminated, all files belonging to the application are compressed again. The Space Doubler cannot be applied to data.

### SUMMARY OF THE INVENTION

It is an object of the invention to improve the efficiency of a memory.

A method of creating a virtual memory space in a memory is proposed which comprises determining whether additional memory space is needed in the memory. If additional memory space is needed, selected portions of memory content stored in the memory are compressed. Memory space which is no longer needed by the compressed selected portions of memory content is released for use as virtual memory space.

Moreover, a memory manager for controlling a memory is proposed. The proposed memory manager comprises a monitoring component monitoring whether additional memory space is needed in the memory. The proposed memory manager further comprises a compression component compressing selected portions of memory content stored in the memory, in case the monitoring component determines that additional memory space is needed, and releasing memory space which is no longer needed by the compressed selected portions of memory content for use as virtual memory space.

Moreover, a system is proposed, which comprises a memory and a memory manager. The memory manager monitors whether additional memory space is needed in the memory, compresses selected portions of memory content stored in the memory, in case it is determined that additional memory space is needed, and releases memory space which is no longer needed by the compressed selected portions of memory content for use as virtual memory space. The proposed system can be given for instance by a single device, like a mobile terminal, but equally be distributed to several devices.

Finally, a software program product in which a software code for creating virtual memory space in a memory is stored is proposed. The software code realizes the steps of the proposed method when running in a memory manager controlling the memory.

The invention proceeds from the consideration that virtual memory space can be created with a single memory as far as required by compressing portions of the content of the memory selectively whenever additional memory space is needed. A portion of memory content can be for instance a data file or any other memory reservation, like a page.

It is an advantage of the invention that the available memory space can be used efficiently with a single type of memory. As long as there is sufficient memory space available, there is no definite need to compress the entire memory content. With the proposed selective compression, it can be ensured that as much of the memory content as possible can be made use of without preceding decompression as long as sufficient memory space is available. When there is no more need for the virtual memory, the released memory spaces may be either left released, or the compressed files may be decompressed back to the memory space, depending on the application.

The invention can be employed in particular, though not exclusively, for creating a virtual memory space in an execution memory, for example in a RAM.

The proposed virtual memory management allows to improve the exploitation of an executable memory by compressing the inactive parts of running applications in the memory. Since inactive modified pages may thus be compressed and stored in the memory in a way occupying significantly less space than without compression, an extra paging storage is not required.

If some memory content is compressed in order to make some amount of additional memory space available in the case of an end-of-memory condition, the requirements of the applications under execution can be satisfied. This adds an extra layer of flexibility to the virtual memory management by minimizing the need for swapping data between the execution memory and a persistent memory. Swapping can be an extremely energy-consuming operation for some memory technologies.

As a result, moreover less volatile and non-volatile memory space is needed. In an optimal case, the virtual memory management might even be realized without any recourse to a non-volatile memory, since the compression can be carried out exclusively within the executable memory. This speeds up the operation considerably.

Even in the worst case, the time required for the respective compression and decompression is not too critical, considering that it allows to prevent a complete stall or termination of an application under execution. Moreover, if both, the compression and the decompression, take place in the execution memory, the delays caused by much slower mass memories of other systems will not be experienced.

The invention can be used with any compression scheme or any combination of compression schemes that supports the proposed approach.

In one embodiment of the invention, the compression is based on a given set of fixed compression tables, not on a dedicated compression table for the respective portion of memory content which is to be compressed. Using fixed compression tables may not result in an optimal compression for each portion of memory content, but it results in a statistically optimal performance for a plurality of parameters as a whole. Since compression tables do not have to be created for each file as in conventional compression schemes, the potential for a very fast compression requiring relatively little processing power and very little overhead is given. Even if individual files are not compressed as well as they could be with dedicated compression tables, a relatively good overall compression ratio can be achieved. If there are many small portions of content, the overall compression may even be particularly good, since the portions of content do not require their own compression table each. The embodiment also has the advantage that it can be adjusted easily to particular demands by changing the number of fixed compression tables. Increasing the number of fixed compression tables results in a better average compression, but in more overhead. Finally, the embodiment is easy to implement.

Using multiple fixed compression tables in order to compress any part of the whole content of a memory has a certain similarity with a codebook method for data transmission, as described for example by Lelewer & Hirschberg in “Data Compression”, ACM Computing surveys, September 1987. In the embodiment of the invention, however, only one version of the codebook is required, not separate ones for a sender and a receiver.

If fixed compression tables are employed, they can either be pre-determined, or be generated dynamically from existing portions of memory content. The latter approach has the advantage that a better compression ratio can be expected. Since the best compression tables vary with the memory content, the system may even check the memory content occasionally in order to determine whether the existing compression tables should be modified. This should be done at a time when the power expenditure does not matter, for example during a charging of the device in which the invention is implemented.

Creating new compression tables dynamically and discarding old ones has been proposed so far only for data transmission, for example in the above cited document “Data Compression”, not for compressing portions of a changing memory content.

Beside the fixed compression tables, at least one additional table may be defined for specific situations.

In one embodiment of the invention employing fixed compression tables, an additional null-table is defined.

When this null-table is associated to a particular portion of memory content as compression table, no operation is applied to the portion of memory content when it is selected for compression. There may be file or code types for which a fixed compression table cannot be used, possibly for bitmap-data, for example. Also, there are situations in which a portion of memory content on which a fixed compression table has been applied is longer than before. In both cases, the null-table should be used. This has the advantage that the proposed system does not break down even when selected portions of memory content cannot be compressed or when selected portions of memory content require their own compression table.

To some portions of memory content, moreover a dedicated compression table may be co-located, as in the case of a WinZip file. In addition or alternatively to the null-table, therefore an own-compression-table may be defined. If the own-compression-table is associated to a selected portion of memory content, this is an indication that a dedicated compression table co-located with the selected portion should be employed instead of a fixed compression table. This allows an efficient compression of those portions of memory content for which fixed compression tables would result in a poor performance.

Using fixed compression tables in combination with the above defined null-table and the above defined own-compression-table provides the system with an advantageous flexibility which allows choosing between a compression with a poorly compressing fixed compression table, no compression at all, and a high-overhead high-quality compression, depending on the specific needs of a running application. Such a flexibility is of great benefit in mobile low-power applications with low memory capacity and requiring fast execution times, though it is not necessarily very relevant in most other environments.

If a set of fixed compression tables is employed, the best-fit compression table for a particular portion of memory content should be determined in a quick analysis when the portion of memory content is written into memory. The determined compression table can then be used later on to compress the portion of memory content.

Since fixed compression tables are used, only a small part of a portion of memory content needs to be scanned to determine the compression table that compresses the portion of memory content most. A partial sample of the portion of memory content is sufficient to identify the best-fit compression table. In test cases, it was sufficient to test about 30% of content portions for obtaining compression tables which did not result in a significant degradation in performance. Even testing only about 10% of content portions gave reasonable results. Selecting a compression table for a specific portion of memory content on the basis of randomly chosen samples of a portion of memory content speeds up the creation of virtual memory still further.

Compression of stored data as known from the state of the art aims primarily at finding the maximum compression ratios, even if this requires considerable overhead. This aspect of a compression is the key issue for most tabletop applications, but in mobile low-power applications, the need to decrease the overhead and the energy consumption required for the compression are equally critical issues.

The actual compression algorithm which is applied to a selected portion of memory content can be for instance a variable-length code, like a Huffman code. The algorithm is not restricted to variable-length codes, however, but can be used with any other substitution code as well. This allows a high flexibility in choosing between cost and performance. It has to be noted, though, that more complex algorithms are also likely to create much overhead. Fairly simple one-pass one-way substitution codes enable moreover a faster processing than complex codes.

The selection of portions which are to be compressed can be based on various criteria. A simple criterion consists in selecting any portions belonging to currently inactive processes for compression. Alternatively or in addition, however, some kind of prioritization could be useful. A prioritization can be employed to ensures that frequently needed portions of memory content are not compressed and decompressed repeatedly.

A particularly simple prioritization can be achieved by associating to each portion of memory content a flag which indicates how many times this portion has already been compressed. Each compression may then increment the flag. Even a one-bit flag could be sufficient. If a flag indicates that a portion of memory content to which it is associated has been compressed frequently or recently, a renewed compression may be avoided, as far as possible in view of the amount of the required memory space.

When a process, to which compressed portions of memory content belong, becomes active again or continues execution, these compressed portions of memory content should be decompressed again in order to make them executable.

In general, a decompression can be carried out on a portion-by-portion basis or on a process basis.

In one embodiment of the invention, a decompression is carried out proactively as soon as sufficient memory space is free. If a compressed portion of memory content is to be transferred to some other location, the employed compression table has to be copied along with the portion of memory content, or the portion of memory content has to be decompressed first. For this reason, an immediate decompression may be desirable in some applications, especially in those in which data is moved frequently from device to device. Without an immediate decompression, a memory manager could moreover report overoptimistic values for the available memory space to applications. The system may then end up in a situation in which the entire memory space has already been compressed when an end-of-memory state is reached once again.

In an alternative embodiment of the invention taking care of the latter problem, compressed portions of memory content are kept compressed until they are needed by some process, but the memory manager reports a status of the available memory space to outside processes which corresponds to an uncompressed status. This means that application-based out-of-memory actions, if any, will be launched, enhancing the memory saving system.

The decompression approach is not a critical part of the invention and may be selected depending on general system and application requirements.

The invention can be implemented for example in a memory manager associated to the memory. The compression algorithm can be implemented either purely in software, or be implemented in hardware in the interface to the memory.

The invention can be implemented in any product in which the memory requirements may exceed the memory capacities. The invention is of particular advantage for a terminal which is mobile and which has the simultaneous requirements of a low power consumption, a high application speed, a limited amount of memory, a limited amount of processing power and a limited need for very-long-term storage. The invention is expected to be particular useful for volatile memories, but can be employed as well for non-volatile memories like Flash-memories and MultiMediaCards (MMC). It can be used in particular for an internal memory of a device, and in particular on those parts of an internal memory containing application code.

The approach according to the invention can be used to compress executable code as well as data code. If used for compressing executable code, the executable code should be decompressed into a separate part of the memory. Compressing as well executable code would be especially useful in the case of a non-volatile RAM (NVRAM).

The approach according to the invention can be combined in an advantageous way with the above described demand paging.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an embodiment of a device according to the invention;

FIG. 2 is a diagram illustrating the organization of a memory in the device of FIG. 1;

FIG. 3 is a first flow chart illustrating the operation in the device of FIG. 1;

FIG. 4 is a second flow chart illustrating the operation in the device of FIG. 1;

FIG. 5 is a diagram illustrating an updating of compression tables in the device of FIG. 1;

FIG. 6 is a diagram illustrating the generation of compression tables;

FIG. 7 is a diagram illustrating the selection of the best compression table;

FIG. 8 is a diagram illustrating the compression of memory content by means of a selected compression table; and

FIG. 9 presents tree structures which can be used for selecting a suitable compression table.

### DETAILED DESCRIPTION OF THE INVENTION

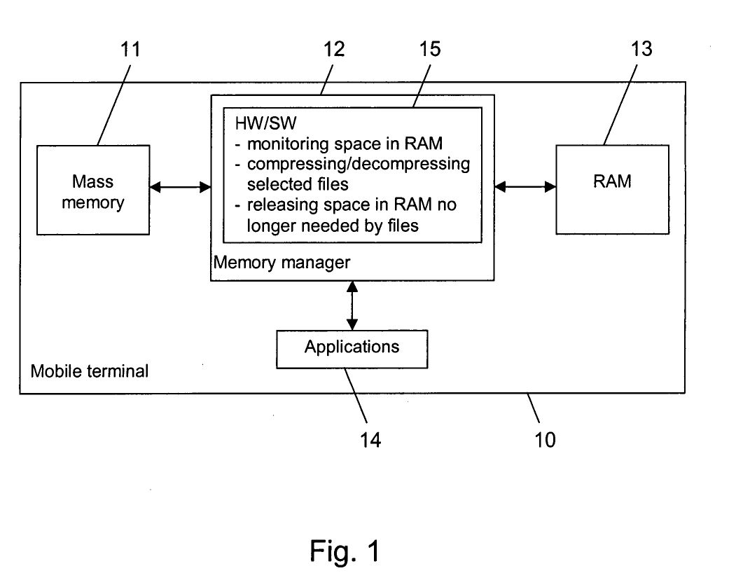

FIG. 1 a schematic block diagram of a mobile terminal 10 in which a virtual memory can be created in accordance with the invention.

The mobile terminal 10 comprises a solid state memory 11 as a mass memory, which is connected via a memory manager 12 to a RAM 13 as executable memory. Moreover, a plurality of applications 14 have access to the RAM 13 via the memory manager 12. The memory manager 12 includes a compression algorithm which is implemented in software SW and/or in hardware HW 15. The mobile terminal 10 may further comprise any other component conventionally included in a mobile terminal. The RAM 13 may or may not have a file system. In the following, the term “file” will be used for any portion of memory content of the RAM 13, for example for a memory reservation or for a page of the memory, especially if the invention is implemented in combination with demand paging.

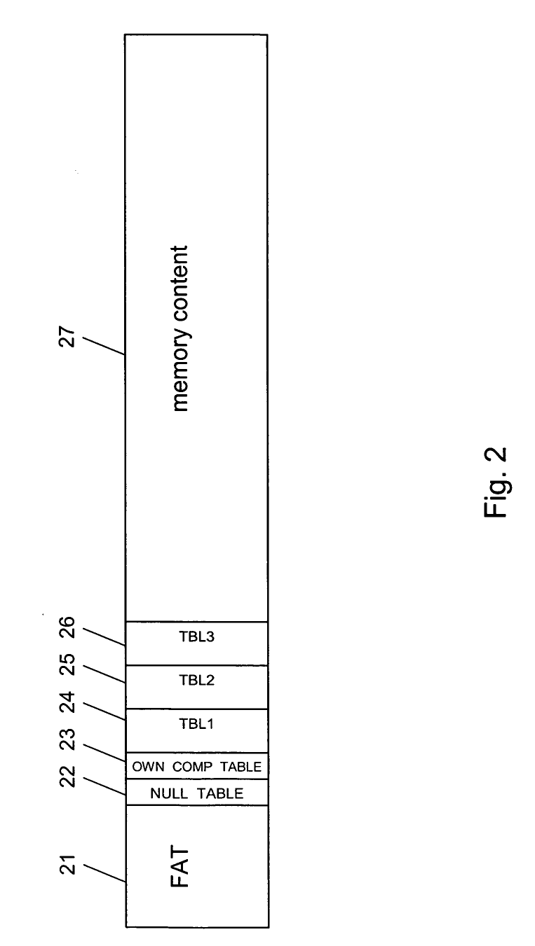

FIG. 2 presents the organization of the RAM 13. The RAM 13 comprises a section 21 for storing a file allocation table FAT, a section 22 for storing a table NULL_TABLE indicating that no compression should be used, a section 23 for storing a table OWN_COMP-TABLE indicating that a compression table co-allocated with a file itself should be used, and a respective section 24 to 26 for storing a plurality of compression tables TBL1, TBL2, TBL3, etc. The rest of the RAM 13 is available for memory content 27 provided by the solid state memory 11 or required by an application 14 during execution.

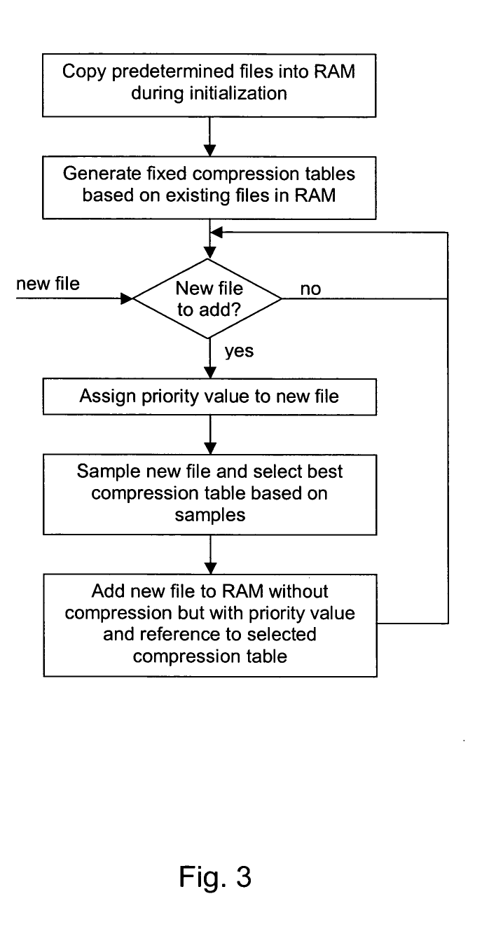

The operation of the memory manager 12 will now be described with reference to FIGS. 3 to 5.

FIG. 3 is a flow chart illustrating the setup of compression tables and the preparation of new files which are to be added to the RAM.

When the RAM 13 is initialized at a start up of the mobile terminal 10, some files of the solid state memory 11 are copied into the RAM 13, for example all files belonging to the operating system of the mobile terminal 10. The memory manager 12 generates a limited set of fixed compression tables TBL1, TBL2, TBL3 based on all or selected ones of the available files in the RAM 13. A compression table associates to each possible value in a particular file a code word such that an optimal compression is achieved for the entire file when the values of the file are substituted by the respectively associated code word. The generated fixed compression tables TBL1, TBL2, TBL3, etc. are stored in sections 24 to 26 of the RAM 13.

When a new file is to be copied from the solid state memory 11 to the RAM 13, for example because a new application is started or because a running application requires an additional file, a priority value is associated to this file. The priority value indicates how critical the respective file is. A high priority can be associated for instance to those files which are needed frequently, while a lower priority can be associated to those files which are needed less frequently.

Further, samples of the new file are selected, and based on these samples it is determined which one of the stored fixed compression tables can be expected to result in an optimal compression when applied to the new file. A corresponding reference to this compression table is associated to the file. If it turns out that none of the stored fixed compression tables can be expected to enable a compression of the file, a reference to the table NULL_TABLE is associated to the file, which reference indicates that this file is not to be compressed. If a dedicated compression table is co-located with the new file itself, a reference to the OWN_TABLE is associated to the file, which reference indicates that this file is to be compressed with the co-located own compression table.

Then, the new file is stored without initial compression into the memory content section 27 of the RAM 13 so that a maximal efficiency is enabled. The associated priority value and the associated reference to one of the compression tables is stored together with the new file.

The described process is repeated for any new file which is to be added to the RAM 13, as long as there is sufficient memory space available.

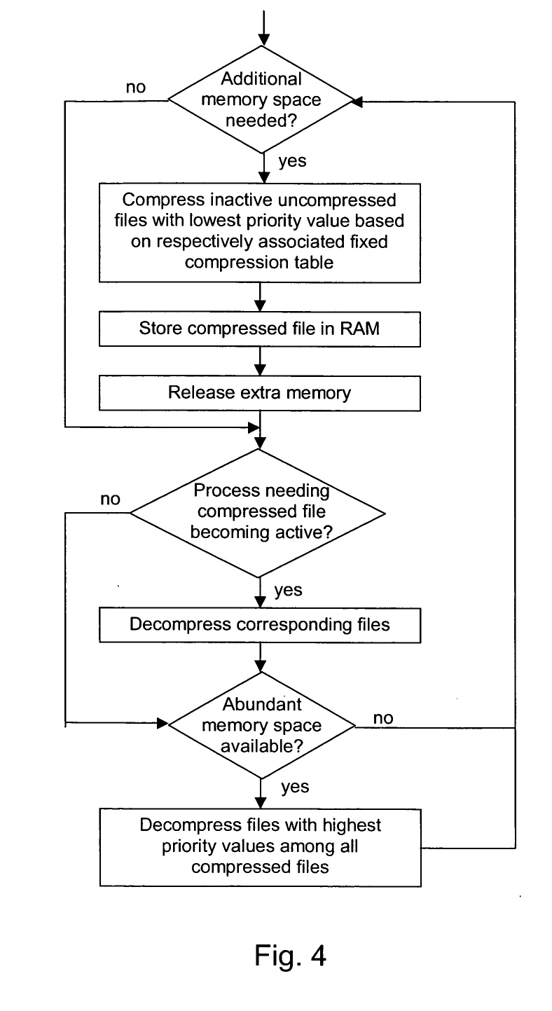

FIG. 4 is a flow chart illustrating the creation of virtual memory space in the RAM 13 if needed.

The memory manager 12 continuously checks whether additional memory space is needed. If it is determines that additional memory space is required, the memory manager 12 selects from the memory content section 27 those inactive but uncompressed files which have the lowest priority. Thereupon, the memory manager 12 compresses each of these files with the compression table TBL1, TBL2, TBL3 associated to the respective file, if any. If the table OWN_COMP_TABLE is associated to a selected file, the compression of this file is performed instead with the compression table co-located with the file. If the table NUL_TABLE is associated to a selected file, no compression is carried out for this file.

The compressed files are written again into the memory content section 27 of the RAM 13, either to a new location or directly over the old file. Now, the extra memory can be released and be used as additional virtual memory space.

The memory manager 12 moreover continuously checks whether a process of an application 14 requiring one of the compressed files in the RAM 13 becomes active. If this is the case, the concerned files are decompressed again and stored into the memory content section 27 of the RAM 13 for use by the application.

The memory manager 12 also checks continuously whether there is abundant memory space available in the RAM 13 so that previously created virtual memory space can be released in order to accelerate the processing of the running applications. If it is determined that virtual memory space can be released, the memory manager 12 decompresses compressed files in the RAM 13, starting with those files to which the highest priority was assigned among all compressed files. The decompressed files are stored again in the RAM 13.

It is understood that with any change in the RAM 13, the memory manager updates the file allocation table FAT in section 21 of the RAM 13.

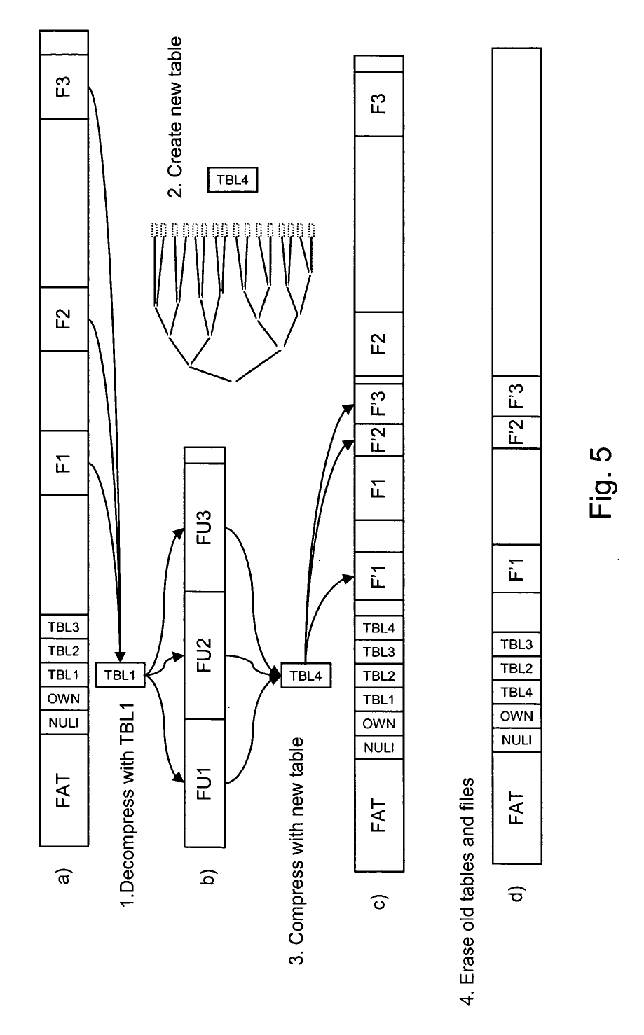

The best set of fixed compression tables TBL1, TBL2, TBL3, etc. varies with the memory content. Therefore, new fixed compression tables may be generated during the runtime of the mobile terminal 10 at specified intervals, and old fixed compression tables which are not used may be deleted. The updating of the fixed compression tables has also an impact on the compressed files, which is illustrated in the diagram of FIG. 5. The updating is carried out best at a time when the power expenditure does not matter, for example during a charging of the mobile terminal 10.

FIG. 5 presents in a first row a) a memory organization, which corresponds to the organization presented in FIG. 2. In addition, three files F1, F2 and F3 are indicated in the memory content section. The three files F1, F2 and F3 are all compressed with a fixed compression table TBL1 stored as first fixed compression table in the RAM 13.

In a first step, the indicated files F1, F2 and F3 are decompressed again with the associated compression table TBL1. The resulting files FU1, FU2 and FU3, respectively, are indicated in a second row b) in FIG. 5.

In a second step, a new fixed compression table TBL4 is generated based on the content of the decompressed files FU1, FU2 and FU3 or of selected ones of the decompressed files FU1, FU2 and FU3. This is indicated in FIG. 5 with a tree structure, which will be explained in detail further below.

In a third step, the decompressed files FU1, FU2 and FU3 are compressed again, this time based on the new fixed compression table TBL4, resulting in compressed files F1′, F2′ and F3′, respectively. The new fixed compression table TBL4 is stored for the compression preliminarily at the end of the existing compression tables TBL1, TBL2, TBL3, etc. The newly compressed files F1′, F2′ and F3′ are stored at some free memory space of the content section in the RAM 13, as indicated in a third row c) in FIG. 5.

In a fourth step, the old compression table TBL1 is erased and substituted by the new compression table TBL4. Moreover, the old compressed files F1, F2 and F3 are erased from the RAM 13. The resulting RAM structure is indicated as a fourth row d) in FIG. 5.

Also the priority values associated to the files in the memory content section 27 of the RAM 13 may be re-evaluated occasionally.

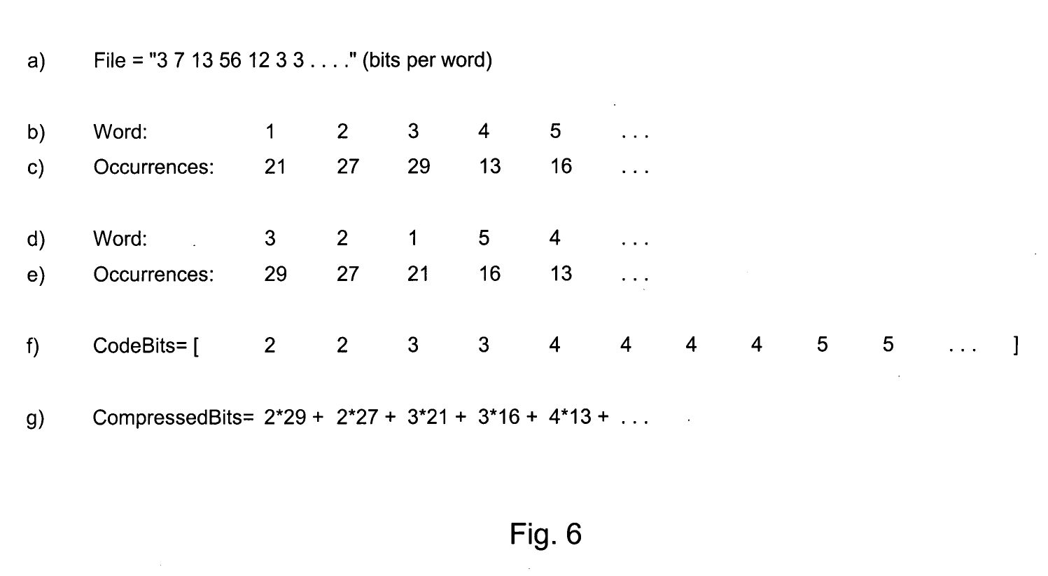

The principle of the generation, the selection and the application of the fixed compression tables will now be explained in more detail for a highly simplified system simulation with reference to FIGS. 6 to 8.

Rather than using actual data, the simulation uses randomly generated files with a maximum file length of 1000 words.

Each word comprises 6 bits and has thus a value between 1 and 64. Although the setup is somewhat artificial, it best illustrates the basic principles and strengths of the algorithm.

FIG. 6 illustrates in seven rows a) to g) the generation of a fixed compression table by means of a sorting tree based on a particular file which is available in the RAM 13.

Row a) presents the available file comprising by way of example words having values of 3, 7, 13, 56, 12 2, 2, etc.

First, to each possible value 1 to 64 of the words, as listed in row b), the number of occurrences in the available file is associated in row c). That is, the word having a value of 1 occurs 21 times in the file, the word having a value of 2 occurs 27 times in the file, the word having a value of 3 occurs 29 times in the file, the word having a value of 4 occurs 13 times in the file, the word having a value of 5 occurs 16 times in the file, etc. The number of occurrences are considered as nodes of an occurrence tree and stored in a FixedTreeNode.

The nodes are then sorted in descending order by the occurrence frequency, as indicated in row e). The associated words, of which the values are indicated in row d), are stored as indices in a FixedTreeIndex. That is, the words appear in the FixedTreeIndex in descending order of their occurrence frequency. The FixedTreeNode and the associated FixedTreeIndex constitute a fixed compression table.

To each of the occurrence frequencies, and thus to each possible word, a different code word is associated.

For an extremely rudimentary code, a variable-length coding is created in which one bit is associated to the most frequently occurring words, two bits are associated to the next most frequently occurring words, etc. The code words are separated by an extra “comma” bit. This does not correspond to a real implementation of a compression scheme, but simulates a system that has a efficiency similar to a normal Huffman coding. The number of bits used for the code words, including the respective comma bit, is given by [2 2 3 3 4 4 4 4 5 5 . . . ], as illustrated in row f) of FIG. 6.

The efficiency of the compression can be measured by determining the total number of code bits of the compressed file resulting when each of the 6-bits words in the available file of row a) is substituted by the code word associated to the respective 6-bit word. The total number of code bits can then be compared with the total number of bits in the original file of row a). For calculating the number of resulting code bits of the compressed file, the products of the occurrence frequency of each word in row e) and the associated number of code bits in row f) are taken and summed, as illustrated in row g) of FIG. 6. For example, the word having a value of 3 occurs 29 times in the file and has associated to it a code word of 2 bits, resulting in a product of 2*29. The word having a value of 2 occurs 27 times in the file and has associated to it a code word of 2 bits, resulting in a product of 2*27. The word having a value of 1 occurs 21 times in the file and has associated to it a code word of 3 bits, resulting in a product of 3*21, etc. The total number of bits in the compressed file is thus 2*29+2*27+3*21+ . . . .

Other available files in the RAM 13 are used in the same way for generating a fixed compression table, until the desired number of fixed compression tables is given. The final set of fixed compression tables may comprise for example ten or twenty tables TBL1, TBL2, TBL3, etc. The files which are employed for generating the set of fixed compression tables are also referred to as basis files.

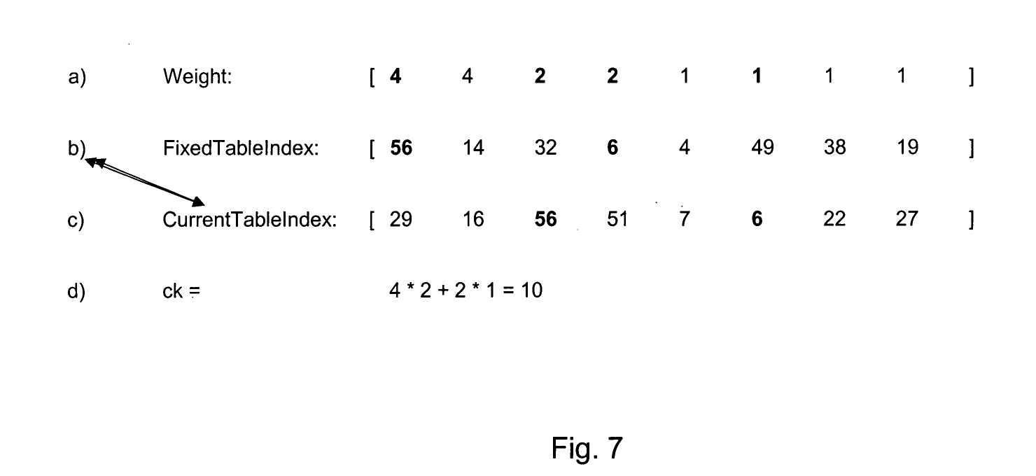

Once the entire set of compression tables TBL1, TBL2, TBL3, etc. has been generated, the best fitting compression table can be selected for any new file that is to be copied into the RAM 13, which is illustrated in four rows a) to d) in FIG. 7.

In order to enable a selection of the respective best fixed compression table for a new file, the first eight indices in the FixedTreeIndex of each compression table are stored in addition and in the same order as indices in a respective FixedTableIndex. Each of these eight indices can be coded with the associated code word with three or less bits, disregarding the respective comma bit. The indices [56 14 32 6 4 49 38 19] of an exemplary FixedTableIndex are presented in row b) of FIG. 7.

Different weights are associated to the different indices in the FixedTableIndex. Indices, that is words, that can be expressed with one bit have a weight of 4, words that can be expressed with two bits have a weight of 2, words that can be expressed with three bits have a weight of 1. These weights are indicated in row a) of FIG. 7. It is understood that other weightings are possible as well.

When a new file is to be stored in the RAM 13, the occurrence frequency of each word in the new file is determined and the determined occurrence frequencies are sorted in a descending order in an occurrence tree as nodes of a CurrentTreeNode. To each occurrence frequency, the corresponding word is associated as index of an CurrentTreeIndex. The first eight indices, or words, in the CurrentTreeIndex are stored in addition in a CurrentTableIndex.

CurrentTreeNode, CurrentTreeIndex and CurrentTableIndex are thus created for the new file just like FixedTreeNode, FixedTreeIndex and FixedTableIndex for the basis files.

The eight words [29 16 56 51 7 6 22 27] of an exemplary CurrentTableIndex are indicated in row c) of FIG. 7.

The best fit table Bfi is found according to the following scheme:

If a given word is represented in both, CurrentTableIndex and FixedTableIndex, a match occurs. In the example presented in rows c) and b), the word having a value of 56 is contained at the first position of the FixedTableIndex and at the third position of the CurrentTableIndex.

Moreover, the word having a value of 6 is contained at the fourth position of the FixedTableIndex and at the sixth position of the CurrentTableIndex. The two matches are indicated in FIG. 7 by two double-headed arrows.

A value ck is defined for comparing the matches of the CurrentTableIndex with the FixedTableIndex of all compression tables k. The value ck for a particular fixed compression table k is calculated by summing the products of the weights associated to the respective same word in both, CurrentTableIndex and FixedTableIndex. In the presented example, the value 56 in the FixedTableIndex is associated to a weight of 4, while the value 56 in the CurrentTableIndex is associated to a weight of 2. A first product is thus given by 4*2. Further, the value 6 in the FixedTableIndex is associated to a weight of 2, while the value 6 in the CurrentTableIndex is associated to a weight of 1. A second product is thus given by 4*2. The value ck in this example is thus 4*2+2*1=10, as indicated in row d) of FIG. 7.

The compression table k with the highest value ck is then selected as the best fitting table for the current new file, and the association is stored for a possible later compression.

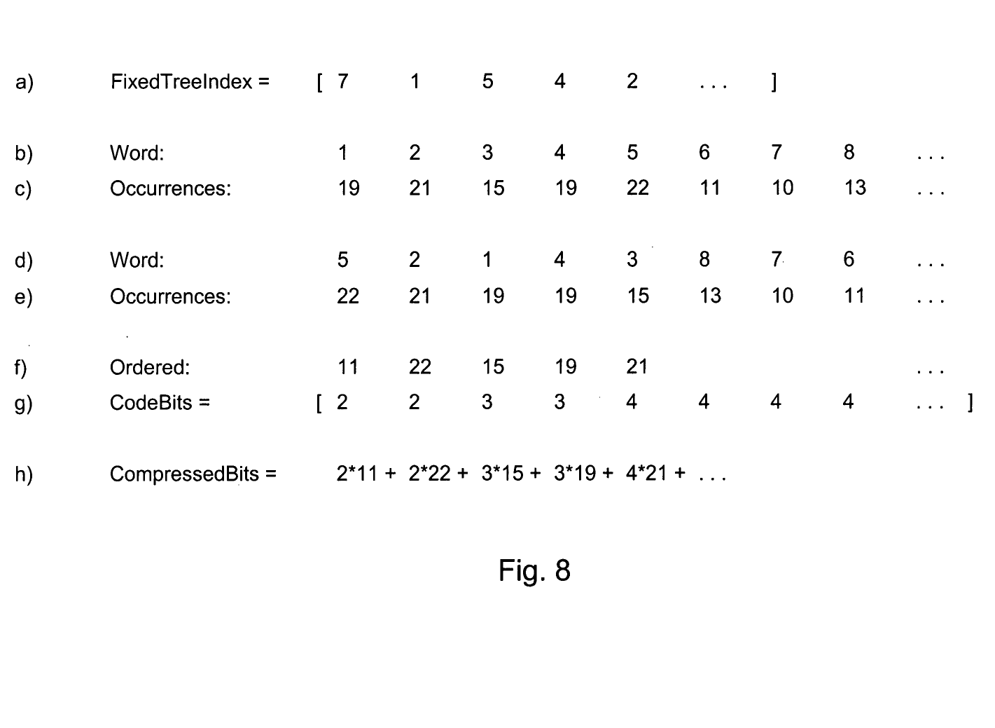

When a fixed compression table TBL1, TBL2, TBL3, etc. has been associated to a file stored in the RAM 13, this file can be selected for compression based on the FixedTreeIndex of the associated fixed compression table in order to create additional virtual memory space, which is illustrated in eight rows a) to h) in FIG. 8.

By way of example, another stored file is to be compressed to which a fixed compression table is associated which has a FixedTreeIndex of [7, 1, 5, 4, 2, . . . ], as indicated in row a) of FIG. 8.

The values of the words of the file and the respective occurrences of the words are indicated in rows b) and c), respectively, in ascending order of the word values 1, 2, 3, 4 etc. The words sorted in descending order of their occurrence frequency, i.e. the CurrentTreeIndex, are indicated in row d), while the associated occurrence frequencies, i.e. the CurrentTreeNode, are indicated in row e). The CurrentTreeIndex has index values of 5, 2, 1, 4, 3, 8, 7, 6, etc. while the CurrentTreeNode has associated index values of 22, 21, 19, 19, 15, 13, 11, 10, etc.

The stored file is now coded in a way that the code word associated to a particular word in the FixedTreeIndex are used for coding the word in the CurrentTreeIndex at a position corresponding to the value of the word in the FixedTreeIndex. For example, the first word in the FixedTreeIndex, to which a first code word of 2 bits is associated, has a value of 7. The word at the seventh position in the CurrentTreeIndex has equally a value of 7 and is now coded with this first 2-bit code word. The second word in the FixedTreeIndex, to which a second code word of 2 bits is associated, has a value of 1. The word at the first position in the CurrentTreeIndex has a value of 5 and is now coded with this second 2-bit code word. The third word in the FixedTreeIndex, to which a first code word of 3 bits is associated, has a value of 5. The word at the fifth position in the CurrentTreeIndex has a value of 3 and is now coded with this first 3-bit code word. All further positions are selected correspondingly for associating the word at the selected position in the CurrentTreeIndex to a particular code word.

The occurrence frequencies with which the respective code words are used are indicated in rows f) and g). The first code word, which is composed of two bits, is used 11 times in the current file, the second code word, which is equally composed of two bits, is used 22 times in the current file, the third code word, which is composed of three bits, is used 15 times in the current file, the fourth code word, which is equally composed of three bits, is used 19 times in the current file, the fifth code word, which is equally composed of four bits, is used 21 times in the current file, etc.

The total number of compressed bits is calculated in row h) of FIG. 8 as the sum over the products between the number of bits of a respective code word and its occurrence frequency in the compressed current file.

If the compressed file becomes larger than the original file, the NULL_TABLE is associated to the current file instead of the previously selected compression table, and the original file is kept.

Next, the generation, selection and application of the fixed compression tables will be described mathematically in a more general form.

The compression scheme implemented in the memory manager 12 is a modification of any known general compression scheme having the following six characteristics:
1. The compression scheme for a file X creates an intermediate function a=f(X). In a Huffman compression, ‘a’ is the alphabet table of the file.
2. The output ‘a’ is used for defining another intermediate function c=g(a,X). In a Huffman compression, ‘c’ is the coded alphabet table.
3. The output ‘c’ is used for defining a compressed file Y=F(c,X)=F(g(a,X),X)=F(g(f(X),X),X).
4. Neither of the functions f, g and F has to be linear, but if the intermediate step a=f(X) is defined for some file X, it has also to be defined for perturbations of the file X′=X+dX according to the equation a′=f(X′)=(l+W)a, where l is the identity operator and where W is the change operator.
5. The output a′ then has to result in c′=g(a′,X′)=g(Da,X′).
6. Further, the output c′ has to result in a new file Y′=F(c′,X′)=F(g(Da,X′),X′)=F(g(f(X′),X′),X′).

In the presented embodiment of the invention, basis files B1 are selected for generating fixed compression tables. For these basis files Bᵢ, basis functions bᵢ=f(Bᵢ), for which Aᵢ=F(g(f(Bᵢ),Bᵢ),Bᵢ), are defined and stored in fixed compression tables. If a file X is to be compressed, for which a maximally compressed file is given by Y0=g(f(X)), one of the basis functions f(Bᵢ) in one of the compression tables is selected for the actual compression. The basis functions f(Bᵢ) can be defined dynamically based on the files in the memory 13 or on other portions of the content of the memory 13.

The file X can be defined more specifically as a difference from a respective basis file Bᵢ, i.e. by X=Bᵢ−Dᵢ. Due to the above defined characteristics of the compression scheme, the following equations hold: f(X)=f(Bᵢ−Dᵢ)=(l+W)f(Bᵢ)=f(Bᵢ)+W(Bᵢ,Dᵢ) and Y0=A_i+z(Bᵢ,Dᵢ, . . . ). One of the basis files Bᵢ will minimize z(Bᵢ, Dᵢ . . . ), and the corresponding basis function f(Bᵢ) will thus compress the file X best among all basis functions f(Bᵢ).

As this basic function f(Bᵢ), the basis function f(Bᵢ) which minimizes the expression |f(X)−f(Bᵢ)| is selected. The distance may be defined by a suitable metric. The selected basis function is then used to compress the file X, resulting in a compressed file Y1=g(f(Bᵢ),X). This is the best compression which can be achieved for the file X with the given basis files Bᵢ.

The respectively best compression table and thus the respectively best basis function f(Bᵢ) may be identified based on all samples of the file X, but a subset of the samples of the file X is sufficient to identify the basis function.

In the following, the selection of the best basis function by means of a simple bitwise operation will be described.

It is assumed that the generated fixed compression tables Tl . . . TN have the alphabets listed in order so that the first word in the table has the shortest representation in the compressed version, as in the FixedTreeIndex of the above presented simplified example. Tkⱼ refers to the j^{th} word in the k^{th} table. The best suited table is now to be found for a file X. To this end, each word Wi in the file X is correlated with the compression tables. The table which fits the data best is selected and used for performing the compression.

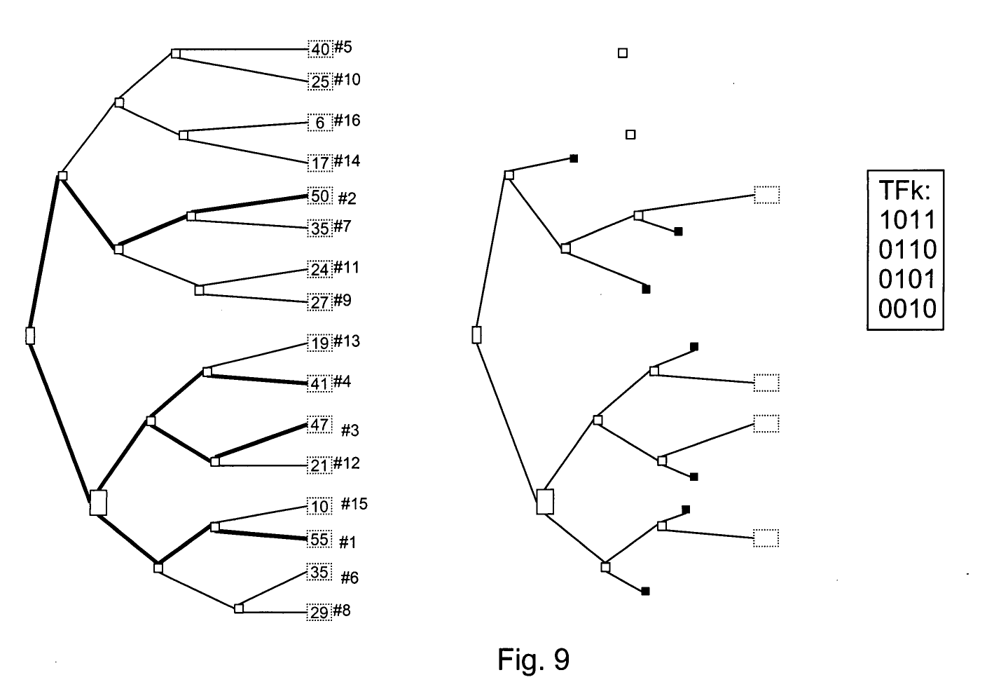

A very efficient way to perform the correlation is to use a tree structure as presented in FIG. 9.

FIG. 9 shows an exemplary complete tree structure on the left hand side, a reduced tree structure in the middle, and a table TFk on the right hand side. The tree structures are established for a system in which the files are composed by way of example of 4-bit words.

In the tree on the left hand side, a starting node is connected to an upper intermediate node and a lower intermediate node, and each intermediate node is equally connected to a further respective upper node and a further respective lower node, and so on. Each possible value of the words of a basis file is represented by a different branch of the tree. Proceeding from the starting node, the respective branch for a specific word value is selected by taking subsequently an upper branch for a ‘1’ and a lower branch for a ‘0’ at each node for each bit in the corresponding word. The respective fourth node in each branch is an end node which terminates the branch and which shows the number of words in the basis file having the word value associated this branch. Next to each end node is an ordering number ordering the branches in a descending order of the occurrence frequency of the associated word values in the basis file.

For finding the best basis function, only the most frequent words in the respective basis file are considered for the correlation. When this list of considered words is small, it can be stored for each compression table k in a separate place as table TFk. In FIG. 9, this table comprises for a table k by way of example the values ‘1011’, ‘0110’, ‘0101’ and ‘0010’.

The tree structure presented in the middle of FIG. 9 corresponds to the tree structure on the left hand side, but comprises only the branches associated to the words in the table TFk. Black boxes indicate that a branch is terminated as it is not associated to one of the words in the table TFk.

In order to find the best fitting fixed compression table for a particular file X, the variable Ck is defined to represent the fit value of table k for file X.

In a first step, the variable Ck is initialized to zero.

In a second step, a word Wi is selected from the file X.

In a third step, it is checked whether the selected word Wi is in the table TFk. To this end, the word is used for following a branch in the search tree bit by bit, starting from the starting node. For each ‘1’, the upper branch is followed at a respective node, and for each ‘0’, the lower branch is followed at a respective node. If the word Wi is not in the table TFk, the search will lead to one of the black boxes and be interrupted. Otherwise, Ck is increment by one or by some weighted value. In the above presented simplified example, the weights were selected for instance based on the occurrence frequency of the respective word in the basis file and the file X.

Steps two and three are repeated for a certain number of words from file X. Either, all words from file X are selected one after the other to this end, or the words are chosen from a random subset of file X.

The same operation is carried out for all available compression tables.

The table k resulting in the highest value Ck is then selected as best fitting compression table.

As mentioned above, the employed algorithm does not require that the entire file X is tested on every compression table. Rather, any subset of the words can be chosen. If the data is read from a RAM, taking such a random sample does not result in a significant loss of speed. If the data speed is the highest when the data is read serially, then one possible embodiment is to read the first 10% of a file X which is to be compressed and to make the selection of the compression table based on this portion of the file X.

Moreover, the variable Ck does not have to be a binary variable, which is incremented either by one or zero when passing through the search tree. For instance, it could also be incremented by fractional values representing the order of compressibility of the different words of a basis file. For example, if the two words in the table TFk of FIG. 9 which can be compressed with the highest factor are ‘1011’ and ‘0010’ and, when disregarding the comma bits, require only one bit each, i.e. 0 or 1, while the next ones ‘0110’ and ‘0101’ require two bits each, the following incrementing values could be associated to the words:
1011: 1
0110: 0.5
0101: 0.5
0010: 1

Such a weighting slows down the calculation to some extent, but it can be expected to give much better results. Especially if a random sampling is used, a weighting is highly recommended.

For the coding, any variable-length encoding, like Huffman, LZ77, etc. can be employed. It is also possible to use more than one algorithm to compress individual file types, for instance with separate tables for each algorithm flagged by an additional flag.

If the encoding does not result in a compression as intended, the above mentioned tables NULL_TABLE or OWN_COMP_TABLE can be used to overcome the problem.

A first-order estimate on whether a compression occurs when a selected fixed compression table is applied to a file X can be gained by compressing the subset of the file that was used to find the best compression table, or a subset of this subset, and by checking the resulting compression ratio. A definite answer, however, requires encoding the entire file. If the file is not compressed by the encoding, it is overwritten with the original file.

It has to be taken into account that with this approach, it is difficult to predict how fast the writing will be, that is how large the time overhead will be. If an overwriting is needed due to a lack of compression, the time may almost double. If the compression tables are well-defined, the probability of a required overwriting will be small, but difficult to predict.

Thus, in one embodiment, enough system time is reserved to statistically handle this case. It is assumed that it is possible to estimate the probability Pnull that the NULL_TABLE has to be used, for instance based on estimates from previous memory writes. The time for checking the tables Tcheck can then be estimated very exactly, either as a fixed time or as a function of the file length, if the number of samples to be tested is predefined. The time to write the original file Traw can be determined exactly when the interface speed and the overhead is known. Compressing the data requires some additional overhead, since the bytes of the file have to be converted to code bytes. In practice, a good estimate is achieved by modeling the compression as follows: Each byte is read into a cache, which takes a time of approximately Traw, the corresponding code is identified, resulting in an additional time overhead which is expressed as Kcheck*Traw, and written directly to the file, taking a time of approximately Traw. The resulting total time is then approximately (2+Kcheck)*TRaw. The time that needs to be statistically reserved is thus Pnull*Traw+(1−Pnull)*(2+Kcheck)*TRaw. This is a good long-term average, but individual file write times may vary widely.

If predictability is favored over efficiency, another embodiment can be selected. In this embodiment, two memory blocks A and B are reserved, which both have the same length as the original file. The data is then written in suitable-length blocks alternately to block A and block B, so that block A contains the data in the original file and B the compressed data. If a compression can be achieved, the writing to block B will end before the writing to block A. The writing can be stopped and block A be released. If no compression occurs, the writing to block A will be completed first, which then contains the exact contents of the original file. The writing can be stopped and block B be released. The time reservation is always TRaw+(2+Kcheck)*TRaw, and the real writing will take somewhat less.

In order to be able to benefit from the invention, a system requires a memory of a certain size, in which the virtual memory space is to be created. This memory size can be estimated by estimating the memory overhead in the worst case.

The system has several compression tables. The space required in the worst-case can be calculated roughly as follows: For any N bit->M bit alphabet compression, there should be separately sorted N->M and M->N tables for achieving an optimal performance. The size of the tables is (M+N)*(2^{N}) and (M+N)*(2^{M}) bits, respectively. The total size of the tables is thus TABLESIZE=(M+N)*(2^{M}+2^{N}). Since in a worst-case scenario, M is equal to N, and in a more typical scenario M is approximately equal to (N−1), a good approximation of the total size of the tables is TABLESIZE−N*2^{(N+2)}.

For N=8 this means that 8*2¹⁰ bits and thus approximately 1 kB are required for one table. For N=10, 10*2¹² bits and thus approximately 5 kB are required for one table. Proceeding from this estimation, it is possible to estimate a minimum memory size for which the scheme is of advantage. The compression scheme should compress the memory by at least a few percent. Thus, a reasonable table overhead should be about 1% at a maximum. If there are approximately 10 different compression tables, the tables will take up about 10 kB of the memory, or approximately 1% of a 1 MB memory. Thus, the total memory capacity is preferably in the MB range or above.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method of creating a virtual memory space in a memory, said method comprising:
determining whether additional memory space is needed in said memory;
if additional memory space is needed, compressing selected portions of memory content stored in said memory; and
releasing memory space which is no longer needed by said compressed selected portions of memory content for use as virtual memory space.

2. The method according to claim 1, wherein a plurality of fixed compression tables are defined for realizing said compression, each fixed compression table associating possible values of memory content to values of a compression code, said method further comprising associating to a respective portion of memory content the fixed compression table resulting in the highest compression when applied to this portion of memory content.

3. The method according to claim 2, wherein said fixed compression tables are predetermined.

4. The method according to claim 2, wherein said fixed compression tables are generated at an initialization of said memory based on available portions of memory content.

5. The method according to claim 4, wherein said fixed compression tables are updated at regular intervals based on available portions of memory content.

6. The method according to claim 2, wherein in addition to said fixed compression tables, a null-table is provided which can equally be associated to a respective portion of memory content and which causes that no modification is applied to a selected portion of memory content to which said null-table is associated.

7. The method according to claim 2, wherein in addition to said fixed compression tables, an own-compression-table is provided which can equally be associated to a respective portion of memory content and which indicates that a portion of memory content to which it is associated has its own compression algorithm co-located and that this own compression algorithm is to be used for a compression of said portion of memory content when selected.

8. The method according to claim 2, wherein a fixed compression table is associated to a respective portion of memory content when said portion of memory content is written into said memory.

9. The method according to claim 2, wherein a fixed compression table is selected for association to a particular portion of memory content based on samples of said particular portion of memory content.

10. The method according to claim 1, wherein portions of memory content are selected for compression which belong to a currently inactive process.

11. The method according to claim 1, wherein different priorities are assigned to different portions of memory content, and wherein those portions of memory content are selected for compression to which the lowest priority has been assigned among all uncompressed portions of memory content.

12. The method according to claim 1, further comprising monitoring whether sufficient memory space is available in said memory and decompressing compressed portions of memory content of said memory as soon as sufficient memory space is available in said memory.

13. The method according to claim 1, further comprising decompressing a compressed portion of memory content of said memory as soon as a process to which said compressed portion of memory content belongs becomes active.

14. The method according to claim 1, further comprising when reporting to an application the status of the memory, reporting a status which would be given in case of a completely decompressed memory content.

15. The method according to claim 1, wherein said memory is an executable memory, to which said portions of memory content are provided by a solid-state memory based on demand paging.

16. A memory manager for controlling a memory, said memory manager comprising:
a monitoring component monitoring whether additional memory space is needed in said memory; and
a compression component compressing selected portions of memory content stored in said memory, in case said monitoring component determines that additional memory space is needed, and releasing memory space which is no longer needed by said compressed selected portions of memory content for use as virtual memory space.

17. A system comprising:
a memory; and
a memory manager monitoring whether additional memory space is needed in said memory, compressing selected portions of memory content stored in said memory, in case it is determined that additional memory space is needed, and releasing memory space which is no longer needed by said compressed selected portions of memory content for use as virtual memory space.

18. A software program product in which a software code for creating virtual memory space in a memory is stored, said software code realizing the following steps when running in a memory manager controlling said memory:
determining whether additional memory space is needed in said memory;
if additional memory space is needed, compressing selected portions of memory content stored in said memory; and
releasing memory space which is no longer needed by said compressed selected portions of memory content for use as virtual memory space.
